(19) United States
(12) Patent Application Publication
(10) Pub. No.: US 2025/0355580 A1
(43) Pub. Date: Nov. 20, 2025

(54) POWER NEGOTIATION FOR MEMORY SYSTEMS

(71) Applicant: Micron Technology, Inc., Boise, ID (US)

(72) Inventor: Keith Neil MacLean, Loveland, CO (US)

(21) Appl. No.: 19/192,248

(22) Filed: Apr. 28, 2025

Related U.S. Application Data
(60) Provisional application No. 63/648,586, filed on May 16, 2024.

(51) Int. Cl. G06F 3/06

(52) U.S. Cl. CPC G06F 3/0625; G06F 3/0659; G06F 3/0679

(57) ABSTRACT

Methods, systems, and devices for power negotiation for memory systems are described. A system may include a host system and one or more drives (e.g., memory systems, memory devices), and may support host-negotiated power control, drive-negotiated power control, or both. In host-negotiated power control, a drive may request to transition to a higher power state than a current power state, and the host system may notify the drive to advance to the higher power state if additional power is available. The drive may also request an incremental power amount. In drive-negotiated power control, one or more drives may draw current, proportional to a respective power usage, from one or more sense pins. A drive may pull additional power if a voltage associated with a total system power usage satisfies a threshold voltage associated with a maximum available system power, or may abort if the voltage falls below the threshold.

### CROSS REFERENCE

The present Application for patent claims priority to U.S. Patent Application No. 63/648,586 by MacLean, entitled “POWER NEGOTIATION FOR MEMORY SYSTEMS,” filed May 16, 2024, which is assigned to the assignee hereof, and which is expressly incorporated by reference in its entirety herein.

### TECHNICAL FIELD

The following relates to one or more systems for memory, including power negotiation for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports power negotiation for memory systems in accordance with examples as disclosed herein.

FIG. 2 shows an example of a system that supports power negotiation for memory systems in accordance with examples as disclosed herein.

FIG. 3 shows an example of a system that supports power negotiation for memory systems in accordance with examples as disclosed herein.

FIG. 4 shows a block diagram of a memory system that supports power negotiation for memory systems in accordance with examples as disclosed herein.

FIG. 5 shows a block diagram of a host system that supports power negotiation for memory systems in accordance with examples as disclosed herein.

FIGS. 6 through 8 show flowcharts illustrating a method or methods that support power negotiation for memory systems in accordance with examples as disclosed herein.

### DETAILED DESCRIPTION

A computing system may include a host system coupled with multiple different memory systems. Some non-volatile memory systems, such as storage drives (e.g., solid-state drives (SSDs), hard-drives (HDDs)), may operate according to different power states defined by software of the host system, where each power state may mandate a maximum amount of power (e.g., maximum power level, maximum power threshold) that a drive may draw at a time. A limiting factor for maximum drive power may in some cases be a total system's ability to dissipate heat. For example, a server system may be designed to be able to dissipate heat generated when drives of the system operate at corresponding maximum power consumptions. One or more drives dissipating a power lower than a respective maximum power may result in wasted margin for other drives (e.g., as such drive may otherwise be able to provide additional performance than that dictated by the current power state set by the host). Such power limitations may result in unnecessary throttling of host performance (e.g., throughput, quality of service (QOS)) as the system may be unable to realize additional performance potential.

According to techniques described herein, a drive may be enabled to draw more power than a configured maximum power level using either host-negotiated or drive-negotiated power control. Host-negotiated power control, or host negotiation, may involve a drive notifying a host of throttling. For example, a drive may send a request to transition to a higher power state, for example, if the drive is operating at a maximum power draw for a current state or estimates exceeding a maximum power draw for the drive. In response, the host may notify the drive to advance to the higher power state if additional power is available. The drive may also request a drive-defined incremental power amount. Additionally, or alternatively, in drive-negotiated power control, or drive negotiation, one or more drives may include a sense pin used to test and increase power draw if available. For example, each drive may draw a current from a respective sense pin of the drive that is proportional to a current power use of the drive. To request more power (e.g., when at a maximum power limit), a drive may increase a current pulled from the sense pin proportional to a desired increase in power. If a voltage of the sense pin is still above a threshold voltage associated with a maximum supported power of the system, then the drive may increase power draw.

Power negotiation among drives and host systems (e.g., drive power negotiation, asynchronous or dynamic negotiation) may provide for better power efficiency by allowing more power to be allocated where it is needed in a dynamic power use environment, resulting in higher overall system power efficiency. For example, drives may have a power cost when running and so using dynamic power negotiation may introduce higher efficiency compared to a static power offset or cost. Performance may also be increased, allowing drives to deliver higher performance as requested (or demanded/commanded) by a host system than would otherwise be possible. Further, power negotiation may prevent unnecessary host system workload latency due to underutilization of power in a storage or compute server. Cooling efficiency may also be increased by allowing each drive to dissipate more power without increasing a fan speed, better utilizing active cooling of server airflow devices. For example, even at a minimum fan speed, server fans may deliver far more cooling than needed given a particular configuration of drive power dissipation, and so a drive may dissipate more power using host or drive negotiation without having a fan speed increase, and thus may better utilize active cooling of server airflow devices.

In addition to applicability in memory systems as described herein, techniques for power negotiation for memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling higher performance and power efficiency in systems involving host systems and storage devices (e.g., by supporting high performance computing situations with large storage requirements, such as in servers with multiple storage drives), which may decrease processing or latency times, improve response times, or otherwise improve user experience, among other benefits.

In addition to applicability in memory systems as described herein, techniques for power negotiation for memory systems may be generally implemented to support cloud computing and storage applications. As the use of cloud computing to provide processing, storage, and networking services to multiple devices increases, many devices and systems may benefit from improved remote processing and storage capabilities. For example, increasing memory capacity or other capabilities may result in larger and more accessible storage options for users, and increasing memory access times may result in faster processing for computing or database applications. Implementing the techniques described herein may support cloud computing and storages techniques by increasing performance and power efficiency at cloud servers and other large storage environments (e.g., by supporting high performance computing situations with large storage requirements, such as in servers with multiple storage drives), resulting in increased response times, and decreased processing times, among other benefits.

In addition to applicability in memory systems as described herein, techniques for power negotiation for memory systems may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving performance and efficiency at edge computing devices, among other benefits.

Features of the disclosure are illustrated and described in the context of systems, devices, and circuits. Features of the disclosure are further illustrated and described in the context of systems, block diagrams, and flowcharts.

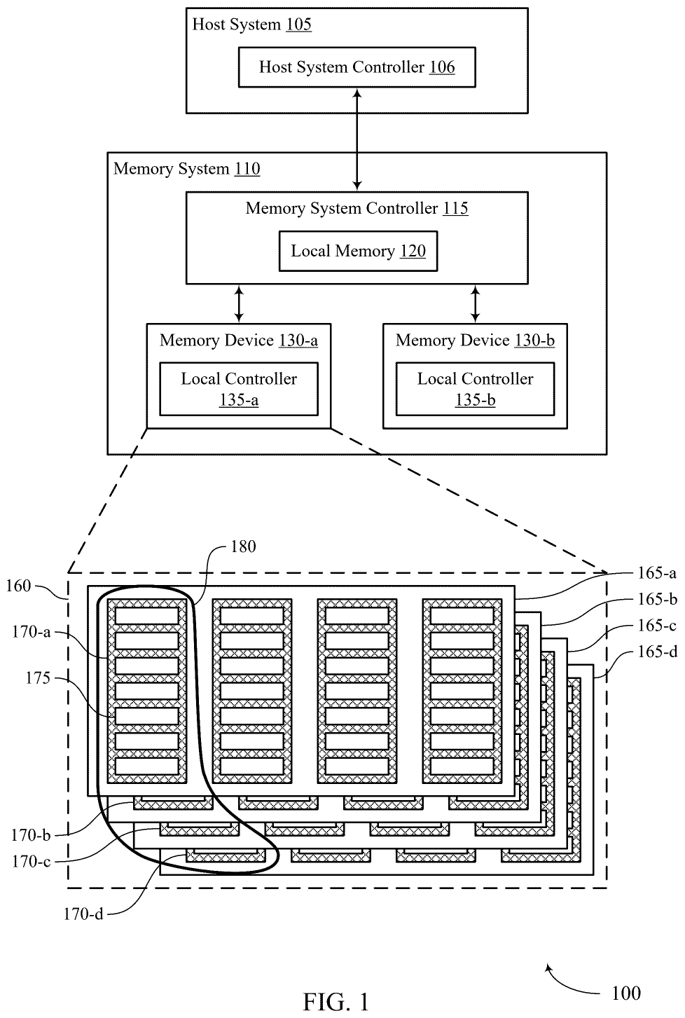

FIG. 1 shows an example of a system 100 that supports power negotiation for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

As described herein, the system 100 may allow one or more drives (e.g., memory systems 110, memory devices 130) to draw more power than a default maximum power level using either host-negotiated or drive-negotiated power control. For example, one or more memory systems 110 or memory devices 130 coupled with the host system 105 may request to transition to a higher power state, and the host system 105 may notify the drive to advance to the higher power state if additional power is available. The drive may also request a drive-defined incremental power amount. Additionally, or alternatively, one or more memory systems 110 or memory devices 130 may draw a current from a sense pin (e.g., where respective sense pins may be coupled together to a resistive element) that is proportional to a current power use, and may either pull additional power if a voltage threshold at the sense pin is still satisfied (e.g., greater than, greater than or equal to the threshold) or may back off from additional power draw if a voltage fails to satisfy (e.g., is less than, is less than or greater than) a threshold. The described techniques may apply to one or more memory devices 130 and one or more types of memory systems 110 having various shapes and sizes (e.g., may be applicable to any drive form factor).

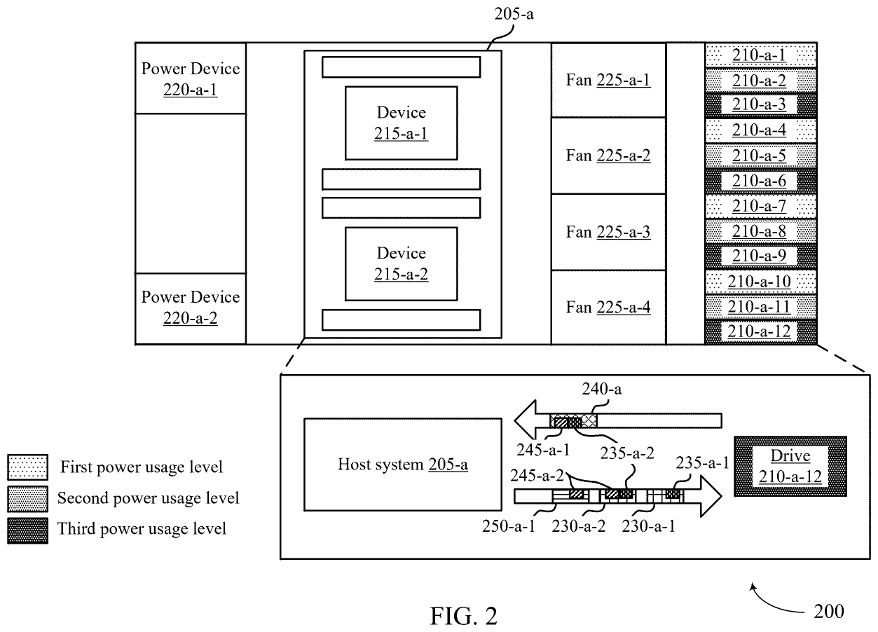

FIG. 2 shows an example of a system 200 that supports power negotiation for memory systems in accordance with examples as disclosed herein. One or more aspects of the system 200 may be implemented by one or more aspects of the system 100. For example, the system 200 may include a host system 205, such as a host system 205-a, in communication with multiple drives 210, including drives 210-a-1, 210-a-2, 210-a-3, 210-a-4, 210-a-5, 210-a-6, 210-a-7, 210-a-8, 210-a-9, 210-a-10, 210-a-11, and 210-a-12, among other devices, which may represent a host system 105 and memory systems 110, respectively. In some examples, the system 200 may support power negotiation in memory systems, for example, including host-negotiated power control as described herein.

The system 200 may be an example of a server (e.g., host server, compute server, cloud server). For example, the host system 205-a may include one or more devices 215, including a device 215-a-1 and a device 215-a-2. The devices 215 may in some cases represent CPUs or other controllers of a single host system or separate host systems, which may be used for controlling the drives 210. The system 200 may further include one or more power devices 220, including power devices 220-a-1 and 220-a-2, which may be examples of power supply units (PSUs). The system 200 may in some cases be configured for heat management.

Drives 210 (e.g., SSDs, HDDs) may operate within a power state defined by the host system 205-a (e.g., defined by host software implemented by one or more CPUs). A power state may allocate (e.g., mandate) a maximum power that each drive 210 may draw at a moment in time. In some cases, a drive 210 may throttle host performance (e.g., throttle throughput and QoS) in order to maintain power dissipation below the maximum power associated with the configured power state. This may maintain system power dissipation (e.g., shared power consumption across devices with an associated amount of generated heat) below an overall system limit. A limiting factor for maximum drive power for the drives 210 may be an ability of the system 200 to dissipate heat (e.g., dissipate a total amount of heat generated by devices of the system). For example, the system 200 may be designed with appropriate devices (e.g., fans 225, including fans 225-a-1, 225-a-2, 225-a-3, and 225-a-4, among other cooling units) to be able to dissipate an amount of heat that is generated when each of the drives 210 are operating at a respective maximum power consumption for a configured power state. However, it may be rare that each of the drives 210 coincidentally dissipates a respective maximum power of the configured power state, resulting in an allowable margin for some drives 210 to dissipate more power than that dictated by a current power state set by the host system 205-a.

For example, the system 200 may accommodate the twelve drives 210-a-1 through 210-a-12 (e.g., SSDs or HDDs) where the fans 225-a-1 through 225-a-4 may be sized so that components of the system 200 (including downwind devices 215-a-1 and 215-a-2, such as CPUs) may operate below respective maximum allowable temperatures at corresponding respective maximum power dissipation. In an example, each of the drives 210 may be set to a same power state (e.g., nonvolatile memory express (NVMe) power state), and thus may be budgeted to dissipate a same total power (e.g., 25 W). However, drives 210-a-1, 210-a-4, 210-a-7, and 210-a-10 may be idle, and may dissipate a first power (e.g., 5 W), while drives 210-a-2, 210-a-5, 210-a-8, and 210-a-11 may operate below maximum performance at a second power (e.g., 15 W) and a total of four drives 210-a-3, 210-a-6, 210-a-9, and 210-a-12 may operate at the maximum allowable power (e.g., 25 W). However, each of the drives 210 may be capable of operating up to a power (e.g., 30 W) that may be higher than the maximum allowable power configured by the host system 205-a, and thus a total power budgeted for the drives 210 may be greater than a power currently in use (e.g., the power budget may be 12×25 W=300 W, but the drives may only dissipate 180 W). Thus, there may be opportunities to enable higher performance in one or more drives 210 to increase a performance of the host system 205-a, although some systems may lack implementation to utilize such remaining power.

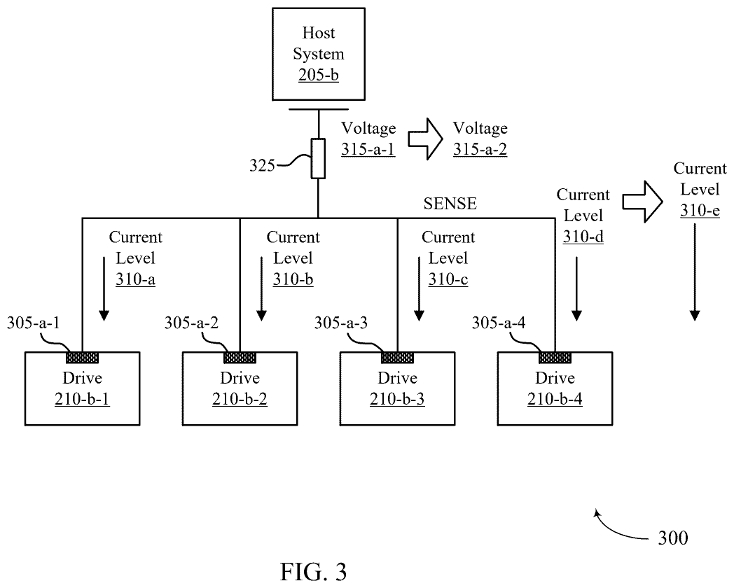

As described herein, the system 200 may support methods in which a drive may be utilized to draw more power than a configured maximum power level, including methods which a drive may utilize to detect when to negotiate for higher power draw. A host system 105 and one or more drives 210 may support at least one of two different protocols for negotiation of higher power at a drive 210, including host-negotiated power control and drive-negotiated power control. In some examples, FIG. 2 may illustrate host-negotiated power control, while FIG. 3 may illustrate drive-negotiated power control. For example, the host system 205-a may, in some cases, be unaware of workload demands (both external and internal) of each drive 210, and thus additional mechanisms may be supported so that the host system 205-a may be notified that a drive 210 is throttling performance due to power, and that more performance may be delivered if the drive 210 is allowed to utilize more power. Thus, when a drive 210 detects that the drive 210 is unable to deliver further performance to the host system 205-a due to constraints of a current power state, the drive 210 may request the host system 205-a to allow the drive 210 to draw additional (e.g., more, higher) power as described herein.

For example, a drive 210, such as the drive 210-a-12, may receive a command 230, such as a command 230-a-1, that may indicate a power state 235-a-1 of multiple potential power states 235 supported for one or more drives 210 of the system 200. The power state 235-a-1 may be associated with a maximum power threshold (e.g., 25 W).

In some cases, a drive 210 may include methods to detect power draw. For example, to know when to request more power from the host system 205-a, the drive 210-a-12 may determine (e.g., detect, calculate, become aware) whether it is currently drawing a maximum allowable power for the drive 210-a-12. For example, the drive 210-a-12 may refrain from drawing more power than allowed by assigning credits to each system operation (e.g., host multiplane (MP) read, garbage collection (GC) MP read, host deallocate, program, erase). A defined quantity of credits may be allowed to be outstanding at any given moment to ensure that a defined power level, or total power level threshold for a power state, is not exceeded. Once a maximum quantity of credits have been issued, new activity may be prevented until outstanding activity completes and credits are returned to a total credit allotment. Once all credits have been issued, a drive 210 may be aware that maximum power dissipation is reached and may request to draw additional power with one or more protocols described herein. Alternatively, a drive 210 may implement power telemetry circuitry which allows the drive 210 to sense how much power the drive 210 is drawing in real time. The circuitry may be polled for real-time power draw or it may interrupt the drive 210 once maximum power is achieved.

Once a drive 210 determines that a maximum power draw has been reached, the drive 210 may request to draw additional power using a request 240. For example, based on determining that an estimated power usage of a workload of the drive exceeds a maximum power threshold (e.g., may estimate a power of 30 W to perform an estimated workload), the drive 210-a-12 may transmit a request 240-a. The drive 210 may also transmit a request 240 based on the threshold being satisfied for a power usage of a current workload (e.g., to be prepared for any increase in workload).

The request 240-a may include a request to transition to a higher-power power state (e.g., NVMe power state) than a current setting, such as to a power state 235-a-2. The host system 205-a may respond to the request 240-a by transmitting a message, such as a command 230-a-2 or an indication message 250-a-1, based on determining whether there is available power. In some cases, the host system 205-a may respond by setting a new power state (e.g., NVMe power state) using power management features or a power management command (e.g., NVMe SET command, vender-unique command, NVMe Asynchronous Event Notification), where the command 230-a-2 may indicate the power state 235-a-2. The drive 210-a-12 may thus begin performing operations according to the new power state. Additionally, or alternatively, the host system 205-a may refrain from action (e.g., may maintain the current power state 235-a-1 at the drive 210-a-12), or may transmit an indication denying the power state alteration.

The host system 205-a may in some examples determine an available amount of power in the system 200 by polling one or more of the drives 210 to determine current power draw, and comparing a total determined power to a maximum supported power of the system 200. For example, the host system 205-a may transmit a request for a drive 210 to measure a respective power draw and report to the host system 205-a, or may receive periodic updates. The host system 205-a may also measure the power draw directly. Additionally, or alternatively, the host system 205-a may keep a general estimate of power usage by storing current power states of all drives 210 (e.g., after assigning the power states to one or more drives), where a sum of assigned power state maximum values may be below or equal to a total supported combined system power.

Additionally, or alternatively, the request 240-a may indicate an amount of incremental power 245-a-1 requested in excess of the maximum power threshold of the power state 235-a-1 (e.g., without an explicit request for a different power state). For example, the drive 210-a-12 may request for a drive-defined number of additional milliwatts (mW) the drive 210-a-12 is requesting to use (e.g., 5,000 mW, 5 W) to deliver additional performance under a current workload. The amount of power requested may be a minimum amount to deliver additional performance, a maximum amount of power the drive 210-a-12 may draw given hardware design constraints (e.g., regulator design, energy to ensure power loss protection), or any value between. The host system 205-a may respond to the requested incremental power 245-a-1 by granting an incremental power 245-a-2 in a message, such as in the indication message 250-a-1 or in the command 230-a-2, to be allocated to the drive 210-a-12. In some examples, the host system 205-a may grant the incremental power 245-a-2 based on current thermal and/or power conditions in the system 200, and the drive may perform operations using the additional incremental power. The incremental power 245-a-2 may be a lower positive value amount of additional power the drive 210-a-12 may be permitted to draw (e.g., 3,500 mW) or a same amount as requested (e.g., 5,000 mW) and may be indicated in the grant for the incremental power 245-a-2. If the host system 205-a determines to not grant the incremental power (e.g., due to a lack of available power in the system 200), the host system 205-a may refrain from action (e.g., maintaining the current power state) or may transmit an indication denying the request.

In some examples, as thermal and/or power conditions change in the system 200, the host system 205-a may command one or more drives 210 to a lower power state. For example, the host system 205-a may send a command 230 (e.g., an NVMe Set Feature, a SET command) to transition the drive 210-a-12 to a defined power state 235 that may be lower than a currently set power state 235. Additionally, or alternatively, the host system 205-a may send an updated message (e.g., indication message 250) indicating an updated amount of additional mW the drive 210-a-12 may be allowed to draw (e.g., a zero amount, a negative amount). For example, the drive 210-a-12 may be granted additional power, and later indicated to use 0 mW of additional power, effectively commanding the drive back to an original power draw of a current power state 235. The host system 205-a may similarly command the drive 210-a-12 to return to the power state 235-a-1 after previously commanding the drive 210-a-12 to increase to the power state 235-a-2.

In some examples, the system 200 may support a messaging system including asynchronous event requests in which a drive 210 may be allowed to send requests back to the host system 205-a. For example, the host system 205-a may support different queues, including an admin queue, or command queue, in which the host system 205-a may input one or more commands (e.g., read, write). Drives 210 may pull commands from the bottom of the command queue (e.g., in a first in first out (FIFO) arrangement). Another queue may be a completion queue (e.g., in a FIFO arrangement) where on completion, a drive 210 may input an entry indicating a completion of one or more requested operations. In some examples, the request 240-a-1 may be an example of an asynchronous event request input into the completion queue as a separate entry, or as a flag or field within a completion entry for one or more completed events. For example, a completion queue entry may include one or more bits that indicate an issue (e.g., failure in smart log, health metric indicating a triggered critical warning, over a temperature limit, over a warning temperature limit, over a critical temperature limit). A bit (e.g., a previously reserved bit) within a completion queue entry may be used to indicate whether a maximum power limit is reached, or one or more bits may indicate a specific power state requested, or an amount of incremental power requested. Similarly, an indication message 250-a-1 or a command 230-a-2 may be an asynchronous event notification input into the command queue, where one or more bits of a command entry may indicate to transition to a next power state, to a specific power state, or an incremental power adjustment. In some cases, such queues may be shared or individual to drives 210, and may be stored at the host system 205-a, the one or more drives 210, or within other memory or devices of the system 200.

By enabling drives 210 to negotiate power consumption, a higher performance may be attained. For example, the four drives at the third power usage level may be allowed to increase power consumption to a maximum drive supported value (e.g., 30 W) so that a total dissipation is higher, but still well within a design of the system 200 (e.g., at 200 W out of a total supported 300 W). This may enable the drives 210 to deliver substantially higher (e.g., significantly higher, by a large amount) performance, which may increase an overall system performance. Thus, a drive 210 may draw more power than a current power state 235 when a host workload demands more performance than the drive 210 can deliver in a current power state.

FIG. 3 shows an example of a system 300 that supports power negotiation for memory systems in accordance with examples as disclosed herein. One or more aspects of the system 300 may be implemented by one or more aspects of the systems 100 and 200. For example, the system 300 may include a host system 205, such as a host system 205-b, in communication with multiple drives 210, including drives 210-b-1, 210-b-2, 210-b-3, and 210-b-4, among other devices, which may represent a host system 105 and memory systems 110, respectively. In some examples, the system 300 may support drive-negotiated power control as described herein. Further, the methods and devices described with respect to the system 300 may be utilized separately or in combination with the methods and devices of the system 200.

In some examples, a pin 305 (e.g., a SENSE pin) may be added to the connection interfaces of one or more drives to allow the drives 210 to sense how much power is currently being drawn across all drives 210 in the system 300. For example, the drives 210-b-1 through 210-b-4 may include pins 305-a-1, 305-a-2, 305-a-3, and 305-a-4, respectively, where each of the pins 305 may couple a drive with a backplane (e.g., supporting structure interconnecting components of the system 200, including the host system 205-b). In some cases, the backplane (e.g., system backplane, server backplane, host backplane) may connect the pins 305 to a defined voltage through a defined resistance 325, where each drive 210 may draw (e.g., sink, pull) current proportional to a respective power usage (e.g., power draw) of a workload of the drive 210 (e.g., a ratio of Watts of drive power draw to milliamps of current). For example, the drive 210-b-4 may draw a current level 310-d (e.g., amount of current) corresponding to an initial power state (e.g., power state 235), while each of the drives 210-b-1 through 210-b-4 may draw a respective current level 310-a, 310-b, and 310-c, respectively. A voltage on any of the pins 305 may be a same voltage 315-a-1, which may correspond to, or be proportional to, a total system power usage (e.g., a ratio of Watts and Volts). The voltage 315-a-1 may indicate how much current is being drawn by all drives 210 in the system 300, as well as how much more current may be drawn before reaching a maximum allowed power draw for the system 300.

The pins 305 may allow a drive 210 to determine how much margin the drive 210 may have to draw additional power, and, if a margin exists to the maximum power allowable, the drive 210 may be allowed to draw more power. For example, the drive 210-b-4 may determine that the voltage 315-a-1 satisfies (e.g., is greater than or equal to, is greater than) a threshold voltage for the host system 205-b backplane that corresponds to a maximum available system power. Based on the determination, the drive 210-b-4 may increase the current draw to pull a second current level 310-e at a higher level of current, and may sense a new voltage 315-a-2 at a second time, where the second current level 310-e may correspond to an estimated power draw of an additional workload of the drive 210-b-4. If the voltage 315-a-2 satisfies the threshold still, the drive 210-b-4 may increase a power draw proportional to the increased current level. However, if the voltage 315-a-2 does not satisfy (e.g., is less than, is less than or equal to) the threshold voltage, the drive 215-b-4 may remain at a same current power draw (e.g., and may reduce the current draw back to the first current level 310-d). In some cases, a drive 210 may attempt additional current draw increases using smaller increments until a power increase is successful without bringing the voltage below the threshold.

In some examples, a pin 305 may be defined or included within one or more defined pins for a drive 210 (e.g., for a memory system), or may be a reserved pin or other pin that is repurposed (either entirely or able to be used for one or more operations) for current sensing, or may be an optional pin. For example, a pin may be defined for use in current sensing in one or more memory configurations or when a drive 210 is connected via a peripheral component interconnect (PCI) interface. Additionally, or alternatively, a pin 305 may be associated with one or more maximum and minimum supported voltages and currents, and one or more minimum and maximum voltage thresholds and current thresholds, among other parameters.

By drawing additional current from a pin 305 and sampling a resulting voltage before increasing a power dissipation, a drive 210 may prevent a maximum system power from being exceeded. For example, if two drives 210 draw additional current from a SENSE pin coincidentally and detect that the maximum system power is exceeded by detecting that a sense pin voltage is lower than allowed, the two drives 210 may abort attempts to draw additional power. In some examples, a drive 210 may wait a quantity of time corresponding to a counter, a defined time quantity, or a sense or backoff window (e.g., random backoff window), after increasing a current pull to ensure that another drive 210 does not also attempt to increase a power draw and that a maximum system power is not exceeded. Additionally, or alternatively, there may be a reserved power defined to protect drives 210 from being kept below a respective power limit by a substantial (e.g., significant, relatively large) amount as other drives 210 increase power through negotiation. For example, one or more drives 210 may determine a total power available as a maximum supported system power minus a reserved power (e.g., reserve power for each drive multiplied by a quantity of drives in the system 300). This way, when drives 210 attempt to utilize available power up to the total power available, there may be some power left over regardless for use by drives 210 currently operating below a power limit of a current power state.

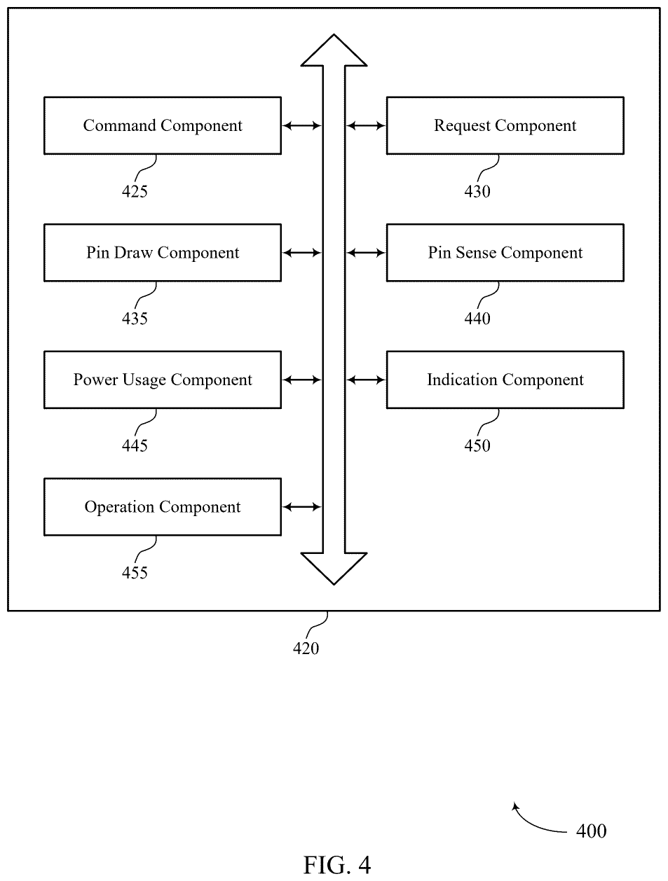

FIG. 4 shows a block diagram 400 of a memory system 420 that supports power negotiation for memory systems in accordance with examples as disclosed herein. The memory system 420 may be an example of aspects of a memory system as described with reference to FIGS. 1 through 3. The memory system 420, or various components thereof, may be an example of means for performing various aspects of power negotiation for memory systems as described herein. For example, the memory system 420 may include a command component 425, a request component 430, a pin draw component 435, a pin sense component 440, a power usage component 445, an indication component 450, an operation component 455, or any combination thereof. Each of these components, or components of subcomponents thereof (e.g., one or more processors, one or more memories), may communicate, directly or indirectly, with one another (e.g., via one or more buses).

The command component 425 may be configured as or otherwise support a means for receiving a first command setting the memory system to a first power state of a plurality of power states, the first power state associated with a first maximum power threshold. The request component 430 may be configured as or otherwise support a means for transmitting, to a host system, a request to increase a power usage at the memory system based at least in part on determining that an estimated power usage of a workload of the memory system exceeds the first maximum power threshold.

In some examples, to support transmitting the request, the request component 430 may be configured as or otherwise support a means for transmitting the request indicating a second power state associated with a second maximum power threshold greater than the first maximum power threshold.

In some examples, the command component 425 may be configured as or otherwise support a means for receiving a second command setting the memory system to the second power state of the plurality of power states based at least in part on the request. In some examples, the second maximum power threshold is greater than the first maximum power threshold. In some examples, the second maximum power threshold is less than the first maximum power threshold.

In some examples, to support transmitting the request, the request component 430 may be configured as or otherwise support a means for transmitting the request indicating a first amount of incremental power requested in excess of the first maximum power threshold.

In some examples, the indication component 450 may be configured as or otherwise support a means for receiving a second indication of a second amount of incremental power allocated to the memory system. In some examples, the operation component 455 may be configured as or otherwise support a means for performing operations of the workload according to the first maximum power threshold and the second amount of incremental power. In some examples, the second amount of incremental power includes a positive value indicating to increase the power usage at the memory system by the second amount of incremental power. In some examples, the second amount of incremental power includes a zero value indicating to maintain the first power state.

The pin draw component 435 may be configured as or otherwise support a means for drawing a first level of current from a pin of the memory system, the first level of current being proportional to a power usage of a workload of the memory system. In some examples, the pin draw component 435 may be configured as or otherwise support a means for drawing a second level of current from the pin, the second level of current being associated with an estimated power usage of an additional workload of the memory system. The pin sense component 440 may be configured as or otherwise support a means for sensing a voltage associated with the pin based at least in part on drawing the second level of current. The power usage component 445 may be configured as or otherwise support a means for altering the power usage at the memory system based at least in part on determining whether the sensed voltage satisfies a threshold voltage.

In some examples, to support altering the power usage, the power usage component 445 may be configured as or otherwise support a means for increasing the power usage at the memory system from a first power level associated with the first level of current to a second power level associated with the second level of current based at least in part on determining that the voltage satisfies the threshold voltage. In some examples, the first power level is associated with a first power state and the second power level is less than a third power level associated with a second power state.

In some examples, to support altering the power usage, the power usage component 445 may be configured as or otherwise support a means for maintaining the power usage at the memory system at a first power level associated with the first level of current based at least in part on determining that the voltage fails to satisfy the threshold voltage. In some examples, the sensing is performed during a sensing window. In some examples, the pin is associated with a minimum supported voltage and a maximum supported voltage associated with performing sensing operations.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

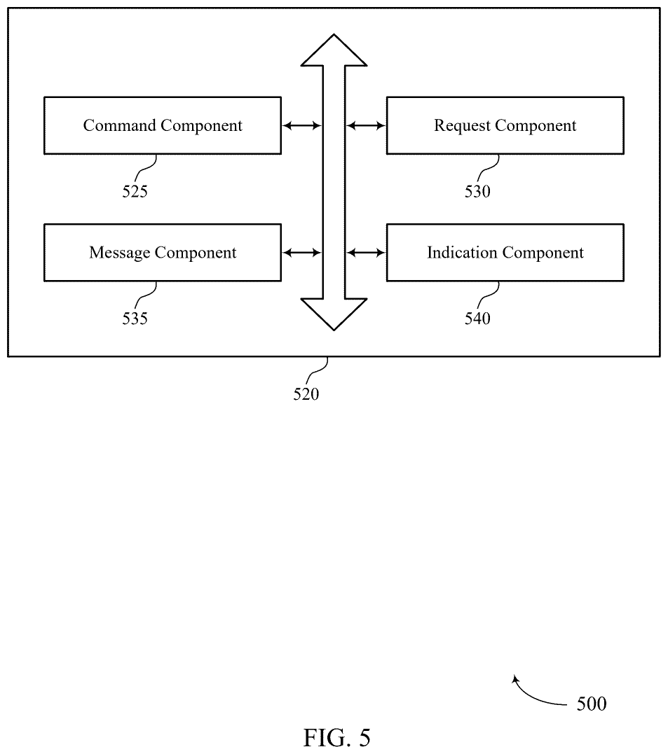

FIG. 5 shows a block diagram 500 of a host system 520 that supports power negotiation for memory systems in accordance with examples as disclosed herein. The host system 520 may be an example of aspects of a host system as described with reference to FIGS. 1 through 3. The host system 520, or various components thereof, may be an example of means for performing various aspects of power negotiation for memory systems as described herein. For example, the host system 520 may include a command component 525, a request component 530, a message component 535, an indication component 540, or any combination thereof. Each of these components, or components of subcomponents thereof (e.g., one or more processors, one or more memories), may communicate, directly or indirectly, with one another (e.g., via one or more buses).

The command component 525 may be configured as or otherwise support a means for transmitting one or more first commands to set a plurality of memory systems coupled with the host system to respective power states of a plurality of power states, each power state of the plurality of power states associated with a respective maximum power threshold. The request component 530 may be configured as or otherwise support a means for receiving, from a memory system of the plurality of memory systems, a request to increase a power usage at the memory system. The message component 535 may be configured as or otherwise support a means for transmitting a message to the memory system based at least in part on the request and determining whether an incremental amount of power associated with the plurality of memory systems is available for the memory system.

In some examples, to support transmitting the message, the command component 525 may be configured as or otherwise support a means for transmitting a second command setting the memory system from a first power state to a second power state of the plurality of power states based at least in part on the request indicating the second power state, where the second power state is associated with a second maximum power threshold different from a first maximum power threshold associated with the first power state. In some examples, the second maximum power threshold is greater than the first maximum power threshold. In some examples, transmitting the second command is based at least in part on determining that the incremental amount of power is available for the memory system. In some examples, the second maximum power threshold is less than the first maximum power threshold. In some examples, transmitting the second command is based at least in part on determining that the incremental amount of power is unavailable for the memory system.

In some examples, to support transmitting the message, the indication component 540 may be configured as or otherwise support a means for transmitting a second indication of a second incremental amount of power allocated to the memory system based at least in part on a first indication of a first incremental amount of power received in the request. In some cases, the second indication may be transmitted via a command or via an indication message, where the message may be a command, an indication message, or another message. In some examples, the message component 535 may include, be coupled with, or communicate or coordinate with the indication component 540 and the command component 525 so that one or more indication messages or commands may be transmitted (e.g., in response to a request). Additionally, or alternatively, the components of FIG. 5 may be coupled or arranged in any configuration (e.g., together or separate in one or more devices) to support performing one or more of the operations described with respect to FIGS. 1-3.

In some examples, the second incremental amount of power includes a positive value indicating to increase the respective maximum power threshold at the memory system by the second incremental amount of power. In some examples, transmitting the second indication is based at least in part on determining that the second incremental amount of power is available for the memory system. In some examples, the second incremental amount of power includes a zero value indicating to maintain the respective power state. In some examples, transmitting the second indication is based at least in part on determining that the incremental amount of power is unavailable for the memory system. In some examples, determining whether the incremental amount of power is available for use is based at least in part on polling one or more of the plurality of memory systems or based at least in part on the respective power states of the plurality of memory systems.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

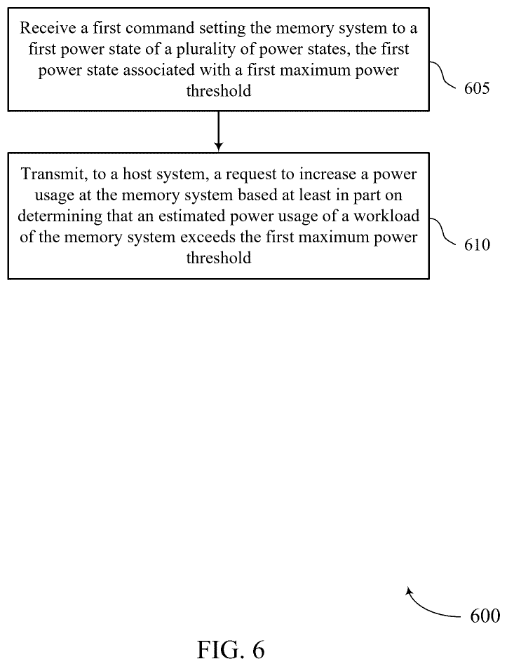

FIG. 6 shows a flowchart illustrating a method 600 that supports power negotiation for memory systems in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a first command setting the memory system to a first power state of a plurality of power states, the first power state associated with a first maximum power threshold. In some examples, aspects of the operations of 605 may be performed by a command component 425 as described with reference to FIG. 4.

At 610, the method may include transmitting, to a host system, a request to increase a power usage at the memory system based at least in part on determining that an estimated power usage of a workload of the memory system exceeds the first maximum power threshold. In some examples, aspects of the operations of 610 may be performed by a request component 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a first command (e.g., command 230) setting the memory system (e.g., drive 210) to a first power state (e.g., power state 235) of a plurality of power states, the first power state associated with a first maximum power threshold and transmitting, to a host system (e.g., a host system 205), a request (e.g., a request 240) to increase a power usage at the memory system based at least in part on determining that an estimated power usage of a workload of the memory system exceeds the first maximum power threshold.
Aspect 2: The method, apparatus, or non-transitory computer-readable medium of aspect 1, where transmitting the request includes operations, features, circuitry, logic, means, or instructions, or any combination thereof for transmitting the request indicating a second power state associated with a second maximum power threshold greater than the first maximum power threshold.
Aspect 3: The method, apparatus, or non-transitory computer-readable medium of aspect 2, further including operations, features, circuitry, logic, means, or instructions, or any combination thereof for receiving a second command setting the memory system to the second power state of the plurality of power states based at least in part on the request (e.g., host system indicates incremental power).
Aspect 4: The method, apparatus, or non-transitory computer-readable medium of aspect 3, where the second maximum power threshold is greater than the first maximum power threshold (e.g., set to higher power state).
Aspect 5: The method, apparatus, or non-transitory computer-readable medium of any of aspects 3 through 4, where the second maximum power threshold is less than the first maximum power threshold (e.g., set to lower power state).
Aspect 6: The method, apparatus, or non-transitory computer-readable medium of any of aspects 1 through 5, where transmitting the request includes operations, features, circuitry, logic, means, or instructions, or any combination thereof for transmitting the request indicating a first amount of incremental power (e.g., an amount of incremental power 245) requested in excess of the first maximum power threshold.
Aspect 7: The method, apparatus, or non-transitory computer-readable medium of aspect 6, further including operations, features, circuitry, logic, means, or instructions, or any combination thereof for receiving a second indication (e.g., via an indication message 250 or via a command 230) of a second amount of incremental power allocated to the memory system and performing operations of the workload according to the first maximum power threshold and the second amount of incremental power (e.g., host system 205 indicates incremental power).
Aspect 8: The method, apparatus, or non-transitory computer-readable medium of aspect 7, where the second amount of incremental power includes a positive value indicating to increase the power usage at the memory system by the second amount of incremental power (e.g., additional incremental power is granted).
Aspect 9: The method, apparatus, or non-transitory computer-readable medium of any of aspects 7 through 8, where the second amount of incremental power includes a zero value indicating to maintain the first power state (e.g., incremental power of OW is indicated to maintain a power state).

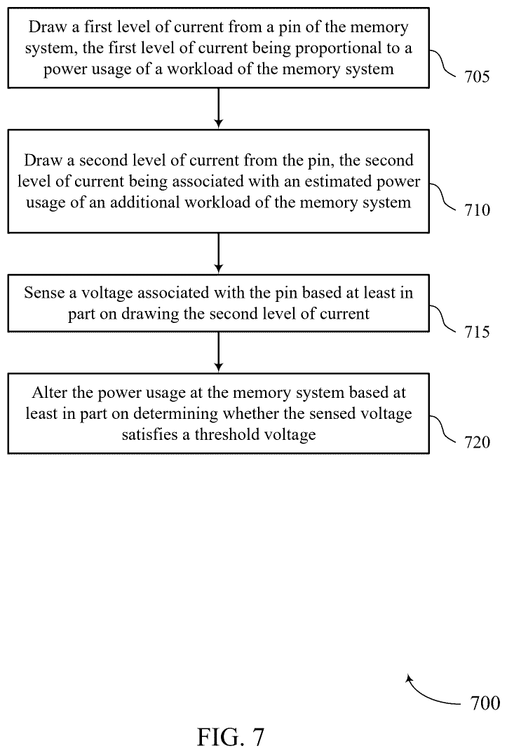

FIG. 7 shows a flowchart illustrating a method 700 that supports power negotiation for memory systems in accordance with examples as disclosed herein. The operations of method 700 may be implemented by a memory system or its components as described herein. For example, the operations of method 700 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 705, the method may include drawing a first level of current from a pin of the memory system, the first level of current being proportional to a power usage of a workload of the memory system. In some examples, aspects of the operations of 705 may be performed by a pin draw component 435 as described with reference to FIG. 4.

At 710, the method may include drawing a second level of current from the pin, the second level of current being associated with an estimated power usage of an additional workload of the memory system. In some examples, aspects of the operations of 710 may be performed by a pin draw component 435 as described with reference to FIG. 4.

At 715, the method may include sensing a voltage associated with the pin based at least in part on drawing the second level of current. In some examples, aspects of the operations of 715 may be performed by a pin sense component 440 as described with reference to FIG. 4.

At 720, the method may include altering the power usage at the memory system based at least in part on determining whether the sensed voltage satisfies a threshold voltage. In some examples, aspects of the operations of 720 may be performed by a power usage component 445 as described with reference to FIG. 4.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 10: A method, apparatus, or non-transitory computer-readable medium including operations, features, circuitry, logic, means, or instructions, or any combination thereof for drawing a first level of current (e.g., a current level 310) from a pin (e.g., a pin 305) of the memory system (e.g., a drive 210), the first level of current being proportional to a power usage of a workload of the memory system; drawing a second level of current from the pin, the second level of current being associated with an estimated power usage of an additional workload of the memory system; sensing a voltage (e.g., a voltage 315) associated with the pin based at least in part on drawing the second level of current; and altering the power usage at the memory system based at least in part on determining whether the sensed voltage satisfies a threshold voltage.
Aspect 11: The method, apparatus, or non-transitory computer-readable medium of aspect 10, where altering the power usage includes operations, features, circuitry, logic, means, or instructions, or any combination thereof for increasing the power usage at the memory system from a first power level associated with the first level of current to a second power level associated with the second level of current based at least in part on determining that the voltage satisfies the threshold voltage (e.g., power usage may be increased when a voltage remains above (or equal to) a threshold).
Aspect 12: The method, apparatus, or non-transitory computer-readable medium of aspect 11, where the first power level is associated with a first power state and the second power level is less than a third power level associated with a second power state (power increase may be incremental instead of by power state).
Aspect 13: The method, apparatus, or non-transitory computer-readable medium of any of aspects 10 through 12, where altering the power usage includes operations, features, circuitry, logic, means, or instructions, or any combination thereof for maintaining the power usage at the memory system at a first power level associated with the first level of current based at least in part on determining that the voltage fails to satisfy the threshold voltage (e.g., power increase may be aborted if a voltage falls below (or equal to) a threshold).
Aspect 14: The method, apparatus, or non-transitory computer-readable medium of any of aspects 10 through 13, where the sensing is performed during a sensing window (e.g., a back-off period may be defined to avoid multiple devices drawing power over a maximum power supported).
Aspect 15: The method, apparatus, or non-transitory computer-readable medium of any of aspects 10 through 14, where the pin is associated with a minimum supported voltage and a maximum supported voltage associated with performing sensing operations.

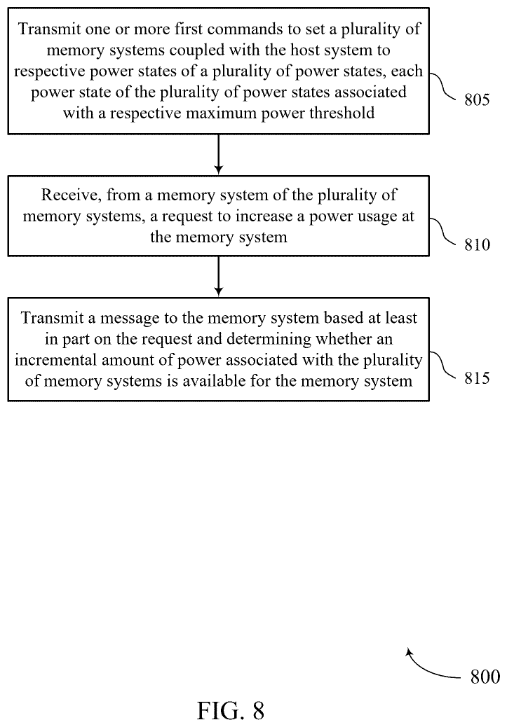

FIG. 8 shows a flowchart illustrating a method 800 that supports power negotiation for memory systems in accordance with examples as disclosed herein. The operations of method 800 may be implemented by a host system or its components as described herein. For example, the operations of method 800 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 805, the method may include transmitting one or more first commands to set a plurality of memory systems coupled with the host system to respective power states of a plurality of power states, each power state of the plurality of power states associated with a respective maximum power threshold. In some examples, aspects of the operations of 805 may be performed by a command component 525 as described with reference to FIG. 5.

At 810, the method may include receiving, from a memory system of the plurality of memory systems, a request to increase a power usage at the memory system. In some examples, aspects of the operations of 810 may be performed by a request component 530 as described with reference to FIG. 5.

At 815, the method may include transmitting a message to the memory system based at least in part on the request and determining whether an incremental amount of power associated with the plurality of memory systems is available for the memory system. In some examples, aspects of the operations of 815 may be performed by a message component 535 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 16: A method, apparatus, or non-transitory computer-readable medium including operations, features, circuitry, logic, means, or instructions, or any combination thereof for transmitting one or more first commands to set a plurality of memory systems (e.g., drives 210) coupled with the host system (e.g., a host system 205) to respective power states of a plurality of power states, each power state of the plurality of power states associated with a respective maximum power threshold; receiving, from a memory system of the plurality of memory systems, a request to increase a power usage at the memory system; and transmitting a message to the memory system based at least in part on the request and determining whether an incremental amount of power associated with the plurality of memory systems is available for the memory system.
Aspect 17: The method, apparatus, or non-transitory computer-readable medium of aspect 16, where transmitting the message includes operations, features, circuitry, logic, means, or instructions, or any combination thereof for transmitting a second command setting the memory system from a first power state to a second power state of the plurality of power states based at least in part on the request indicating the second power state, where the second power state is associated with a second maximum power threshold different from a first maximum power threshold associated with the first power state.
Aspect 18: The method, apparatus, or non-transitory computer-readable medium of aspect 17, where the second maximum power threshold is greater than the first maximum power threshold and transmitting the second command is based at least in part on determining that the incremental amount of power is available for the memory system.
Aspect 19: The method, apparatus, or non-transitory computer-readable medium of any of aspects 17 through 18, where the second maximum power threshold is less than the first maximum power threshold and transmitting the second command is based at least in part on determining that the incremental amount of power is unavailable for the memory system.
Aspect 20: The method, apparatus, or non-transitory computer-readable medium of any of aspects 16 through 19, where transmitting the message includes operations, features, circuitry, logic, means, or instructions, or any combination thereof for transmitting a second indication of a second incremental amount of power allocated to the memory system based at least in part on a first indication of a first incremental amount of power received in the request.
Aspect 21: The method, apparatus, or non-transitory computer-readable medium of aspect 20, where the second incremental amount of power includes a positive value indicating to increase the respective maximum power threshold at the memory system by the second incremental amount of power and transmitting the second indication is a based at least in part on determining that the second incremental amount of power is available for the memory system.
Aspect 22: The method, apparatus, or non-transitory computer-readable medium of any of aspects 20 through 21, where the second incremental amount of power includes a zero value indicating to maintain the respective power state and transmitting the second indication is based at least in part on determining that the incremental amount of power is unavailable for the memory system.
Aspect 23: The method, apparatus, or non-transitory computer-readable medium of any of aspects 16 through 22, where determining whether the incremental amount of power is available for use is based at least in part on polling one or more of the plurality of memory systems or based at least in part on the respective power states of the plurality of memory systems (e.g., a host system 205 may poll power use of drives 210 or may determine whether to grant additional power or power states based on current power states of the drives).

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command setting the memory system to a first power state of a plurality of power states, the first power state associated with a first maximum power threshold; and
transmit, to a host system, a request to increase a power usage at the memory system based at least in part on determining that an estimated power usage of a workload of the memory system exceeds the first maximum power threshold.

2. The memory system of claim 1, wherein transmitting the request comprises the processing circuitry configured to cause the memory system to:
transmit the request indicating a second power state associated with a second maximum power threshold greater than the first maximum power threshold.

3. The memory system of claim 2, wherein the processing circuitry is further configured to cause the memory system to:
receive a second command setting the memory system to the second power state of the plurality of power states based at least in part on the request.

4. The memory system of claim 3, wherein the second maximum power threshold is greater than the first maximum power threshold.

5. The memory system of claim 3, wherein the second maximum power threshold is less than the first maximum power threshold.

6. The memory system of claim 1, wherein transmitting the request comprises the processing circuitry configured to cause the memory system to:
transmit the request indicating a first amount of incremental power requested in excess of the first maximum power threshold.

7. The memory system of claim 6, wherein the processing circuitry is further configured to cause the memory system to:
receive a second indication of a second amount of incremental power allocated to the memory system; and
perform operations of the workload according to the first maximum power threshold and the second amount of incremental power.

8. The memory system of claim 7, wherein the second amount of incremental power comprises a positive value indicating to increase the power usage at the memory system by the second amount of incremental power.

9. The memory system of claim 7, wherein the second amount of incremental power comprises a zero value indicating to maintain the first power state.

10. A memory system, comprising:
one or more memory devices; and
processing circuitry coupled with the one or more memory devices and configured to cause the memory system to:
draw a first level of current from a pin of the memory system, the first level of current being proportional to a power usage of a workload of the memory system;
draw a second level of current from the pin, the second level of current being associated with an estimated power usage of an additional workload of the memory system;
sense a voltage associated with the pin based at least in part on drawing the second level of current; and
alter the power usage at the memory system based at least in part on determining whether the sensed voltage satisfies a threshold voltage.

11. The memory system of claim 10, wherein altering the power usage comprises the processing circuitry configured to cause the memory system to:
increase the power usage at the memory system from a first power level associated with the first level of current to a second power level associated with the second level of current based at least in part on determining that the voltage satisfies the threshold voltage.

12. The memory system of claim 11, wherein the first power level is associated with a first power state and the second power level is less than a third power level associated with a second power state.

13. The memory system of claim 10, wherein altering the power usage comprises the processing circuitry configured to cause the memory system to:
maintain the power usage at the memory system at a first power level associated with the first level of current based at least in part on determining that the voltage fails to satisfy the threshold voltage.

14. The memory system of claim 10, wherein the sensing is performed during a sensing window.

15. The memory system of claim 10, wherein the pin is associated with a minimum supported voltage and a maximum supported voltage associated with performing sensing operations.

16. A host system, comprising:
one or more interfaces comprising one or more signal paths operable for communications with one or more memory systems; and
processing circuitry coupled with the one or more interfaces and configured to cause the host system to:
transmit one or more first commands to set a plurality of memory systems coupled with the host system to respective power states of a plurality of power states, each power state of the plurality of power states associated with a respective maximum power threshold;
receive, from a memory system of the plurality of memory systems, a request to increase a power usage at the memory system; and
transmit a message to the memory system based at least in part on the request and determining whether an incremental amount of power associated with the plurality of memory systems is available for the memory system.

17. The host system of claim 16, wherein transmitting the message comprises the processing circuitry configured to cause the host system to:
transmit a second command setting the memory system from a first power state to a second power state of the plurality of power states based at least in part on the request indicating the second power state, wherein the second power state is associated with a second maximum power threshold different from a first maximum power threshold associated with the first power state.

18. The host system of claim 17, wherein:
the second maximum power threshold is greater than the first maximum power threshold, and
transmitting the second command is based at least in part on determining that the incremental amount of power is available for the memory system.

19. The host system of claim 17, wherein:
the second maximum power threshold is less than the first maximum power threshold, and
transmitting the second command is based at least in part on determining that the incremental amount of power is unavailable for the memory system.

20. The host system of claim 16, wherein transmitting the message comprises the processing circuitry configured to cause the host system to:
transmit a second indication of a second incremental amount of power allocated to the memory system based at least in part on a first indication of a first incremental amount of power received in the request.

21. The host system of claim 20, wherein:
the second incremental amount of power comprises a positive value indicating to increase the respective maximum power threshold at the memory system by the second incremental amount of power, and
transmitting the second indication is a based at least in part on determining that the second incremental amount of power is available for the memory system.

22. The host system of claim 20, wherein:
the second incremental amount of power comprises a zero value indicating to maintain the respective power state, and
transmitting the second indication is based at least in part on determining that the incremental amount of power is unavailable for the memory system.

23. The host system of claim 16, wherein determining whether the incremental amount of power is available for use is based at least in part on polling one or more of the plurality of memory systems or based at least in part on the respective power states of the plurality of memory systems.
